(19) United States
(12) Patent Application Publication
(10) Pub. No.: US 2011/0037035 A1
(43) Pub. Date: Feb. 17, 2011

(54) METHOD OF PREPARING CONDUCTIVE NANO INK COMPOSITION

(75) Inventors: Jong-Hee Lee, Suwon-si (KR); Jae-Myung Kim, Suwon-si (KR); Kyu-Nam Joo, Suwon-si (KR)

Correspondence Address: ROBERT E. BUSHNELL & LAW FIRM, 2029 K STREET NW, SUITE 600, WASHINGTON, DC, 20006-1004, US

(73) Assignee: SAMSUNG SDI CO., LTD., Yongin-si (KR)

(21) Appl. No.: 12/814,587

(22) Filed: Jun. 14, 2010

(30) Foreign Application Priority Data
Aug. 14, 2009 (KR) 10-2009-0075329

(51) Int. Cl. H01B 1/22

(52) U.S. Cl. 252/513; 252/512; 252/514

(57) ABSTRACT

A method of preparing a conductive nano ink composition. The method includes mixing a metal precursor in a solution of a multi-functional polymer having a chemical reduction function and a particle growth suppression function to form a mixture solution, forming primary particles by stirring the mixture solution at about 800 to about 1,200 rpm for about 10 to about 20 minutes, and forming secondary particles by leaving the mixture solution at room temperature.

### RELATED APPLICATIONS

This application claims the benefit of Korean Patent Application No. 10-2009-0075329, filed on Aug. 14, 2009, in the Korean Intellectual Property Office, the disclosure of which is incorporated herein in its entirety by reference.

### BACKGROUND OF THE INVENTION

1. Field of the Invention

One or more embodiments of the present invention relate to a method of preparing a conductive nano ink composition.

2. Description of the Related Art

Inkjet printing technology is used to form fine lines of several tens of micrometers in size by ejecting droplets each with a volume of several to several tens of pico-liters from a solution or a suspension including conductive metal nanoparticles through nozzles. Various attempts have recently been made to apply the inkjet printing technology to an electrode or an electromagnetic wave shield layer of a flat panel display device, such as a plasma display panel (PDP), a liquid crystal display (LCD), or an organic light emitting diode (OLED). In order to apply the inkjet printing technology to a flat panel display device, it is important to prepare nano metal particles of less than several to several tens of nanometers in size and stably disperse the nano metal particles in an ink solution.

Conventional methods of chemically preparing metal nanoparticles that are main ingredients of conductive ink involve a heating process for reducing metal ions and forming particles. The conventional methods have a problem in that due to the heating process, an external heat source is used, thereby increasing manufacturing costs. The conventional methods have another problem of a non-uniform particle size distribution. In the conventional methods, nucleation and particle growth rates during the reaction are so high that it is difficult to achieve uniform particle growth even if a strong particle growth suppressing agent is used, thereby making it difficult to form mono-dispersed nanoparticles. The conventional methods use a metal precursor, a reducing agent for reducing the metal precursor, a dispersion stabilizer for adjusting particle growth and coagulation, and a solvent for dissolving the metal precursor, the reducing agent, and the dispersion stabilizer. The conventional methods have another problem in that since the number of additives necessary for the reaction is so large that material costs are increased, the productivity of metal nanoparticles in a single manufacturing process is reduced, and a non-uniform particle size distribution exists during mass production.

### SUMMARY OF THE INVENTION

One or more embodiments of the present invention include a method of preparing a conductive nano ink composition that may simply form mono-dispersed nanoparticles at low costs and at room temperature.

One or more embodiments of the present invention include a conductive nano ink composition prepared by the method.

One or more embodiments of the present invention include a conductive nano ink composition including water, a multi-functional polymer, and a metal precursor.

According to one or more embodiments of the present invention, there is provided a method of preparing a conductive nano ink composition, the method including: mixing a metal precursor in a solution of a multi-functional polymer having a chemical reduction function and a particle growth suppression function to form a mixture solution; forming primary particles by stirring the mixture solution at about 800 rpm to about 1200 rpm for about 10 minutes to about 20 minutes; and forming secondary particles by leaving the mixture solution at room temperature.

The multi-functional polymer may have a molecular weight ranging from 10,000 to 50,000 daltons.

The multi-functional polymer may be one or more selected from the group consisting of polyvinylpyrrolidone, polyethylenimine, and polyhexanediol diacrylate.

The metal precursor may a compound including one or more metals selected from the group consisting of silver (Ag), gold (Au), platinum (Pt), copper (Cu), nickel (Ni), and palladium (Pd). The metal precursor may be a nitrate, an acetate, or a chloride including one or more metals selected from the group consisting of silver (Ag), gold (Au), platinum (Pt), copper (Cu), nickel (Ni), and palladium (Pd).

The metal precursor may be AgNO₃, HAuCl₄, H₂PtCl₆, or Cu(C₂H₃O₂)₂.

The secondary particles are formed by leaving the mixture solution at a temperature ranging from about 23° C. to about 27° C.

The solution of the multi-functional polymer may be an aqueous solution, and the amount of the multi-functional polymer may be about 70 to about 120 parts by weight, based on 100 parts by weight of water, and the amount of the metal precursor may be about 40 to about 90 parts by weight, based on 100 parts by weight of water.

According to one or more embodiments of the present invention, the method is free from a heating step.

According to one or more embodiments of the present invention, the mixture solution is free from an additional reducing agent.

According to one or more embodiments of the present invention, there is provided a conductive nano ink composition prepared by the method.

According to one or more embodiments of the present invention, there is provided a conductive nano ink composition, wherein the amount of a multi-functional polymer is about 70 to about 120 parts by weight and the amount of the metal precursor is about 40 to about 90 parts by weight, based on 100 parts by weight of water.

According to one or more embodiments of the present invention, there is provided a conductive nano ink composition including mono-dispersed metal nanoparticles, and a multifunctional polymer selected from the group consisting of polyvinylpyrrolidone, polyethylenimine, polyhexanediol diacrylate, and mixtures thereof.

The multi-functional polymer may have a molecular weight ranging from 10,000 to 50,000 daltons.

The multi-functional polymer may be one or more selected from the group consisting of polyvinylpyrrolidone, polyethylenimine, and polyhexanediol diacrylate.

The metal precursor may a compound including one or more metals selected from the group consisting of silver (Ag), gold (Au), platinum (Pt), copper (Cu), nickel (Ni), and palladium (Pd). The metal precursor may be a nitrate, an acetate, or a chloride including one or more metals selected from the group consisting of Ag, Au, Pt, Cu, Ni, and Pd.

The metal precursor may be AgNO₃, HAuCl₄, H₂PtCl₆, or Cu(C₂H₃O₂)₂.

The multi-functional polymer may be polyvinylpyrrolidone.

The conductive nano ink composition may further include a dispersant. According to one or more embodiments of the present invention, there is provided a method of preparing a conductive nano ink composition, the method including: stirring a mixture solution comprised of a metal precursor in an aqueous solution of a multifunctional polymer to reduce a metal ion of the metal precursor by the multifunctional polymer; and placing the mixture solution at a temperature ranging from about 23° C. to about 27° C. to form mono-dispersed metal nanoparticles.

### BRIEF DESCRIPTION OF THE DRAWINGS

These and/or other aspects will become apparent and more readily appreciated from the following description of the embodiments, taken in conjunction with the accompanying drawings of which:

FIG. 1 is a graph illustrating a particle size distribution of a conductive nano ink composition according to an embodiment of the present invention.

### DETAILED DESCRIPTION

A method of preparing a conductive nano ink composition according to an embodiment of the present invention includes mixing a metal precursor in a solution of a multi-functional polymer having a chemical reduction function and a particle growth suppression function to obtain a mixture solution, forming primary particles by stirring the mixture solution at about 800 rpm (revolutions per minute) to about 1200 rpm for about 10 minutes to about 20 minutes, and forming secondary particles by leaving the mixture solution at room temperature.

The forming of the primary particles includes forming fine primary particles by stirring the mixture solution at a high rate for about 10 minutes to about 20 minutes to increase a reduction rate of metal ions and form a large number of nuclei.

According to the one or more of the above embodiments of the present invention, the mixture solution is free from an additional reducing agent.

By stopping the stirring of the mixture solution and leaving the mixture solution at room temperature, secondary nuclei, are formed and ultra-fine secondary particles are allowed to be gradually uniformly absorbed into the primary particles formed by the stirring of the mixture solution, thereby forming mono-dispersed metal nanoparticles having a size of less than or equal to about 10 nanometers.

When the mixture solution is stirred at about 800 to about 1,200 rpm for about 10 to about 20 minutes, the primary particles may be formed to have a size and number suitable for uniformly absorbing the secondary particles.

The multi-functional polymer is a polymer having multiple functions. Since the multi-functional polymer having the chemical reduction function and the particle growth suppression function is used, material costs may be reduced and a large number of fine metal nanoparticles may be formed in a batch.

Polymer materials having a reduction function form a metal ion (M⁺)-polymer structure and reduce metal ions M⁺ into metal particles M⁰ at room temperature, and after the reduction, the metal particles do not experience coagulation and particle growth exceeding several tens of nanometers due to the polymer having excellent particle growth suppression properties.

According to the present embodiment, the multi-functional polymer may have a molecular weight ranging from about 10,000 to about 50,000 daltons.

If the molecular weight of the multi-functional polymer is less than 10,000 daltons, a particle growth rate is increased due to the lack of steric stability and coagulation becomes severe. If the molecular weight of the multi-functional polymer is greater than 50,000 daltons, however, viscosity is greatly increased and mobility is reduced, thereby badly affecting particle growth and uniformity.

According to the present embodiment, the multi-functional polymer may be one or more selected from the group consisting of polyvinylpyrrolidone, polyethylenimine, and polyhexanediol diacrylate.

According to the present embodiment, the metal precursor may a compound including one or more metals selected from the group consisting of silver (Ag), gold (Au), platinum (Pt), copper (Cu), nickel (Ni), and palladium (Pd).

According to the present embodiment, the metal precursor may be a nitrate, an acetate, or a chloride including one or more metals selected from the group consisting of silver (Ag), gold (Au), platinum (Pt), copper (Cu), nickel (Ni), and palladium (Pd). For example, the metal precursor may be AgNO₃, HAuCl₄, H₂PtCl₆, or Cu(C₂H₃O₂)₂.

In the specification and the claims, the term “room temperature” is defined as an indoor temperature of from about 20° C. to about 27° C.

According to the present embodiment, the secondary particles are formed by leaving the mixture solution at a temperature ranging from about 23° C. to about 27° C.

According to the present embodiment, as a ratio of the multi-functional polymer to the metal precursor exceeds 1, a reduction rate of metal ions is increased and spherical mono-dispersed nanoparticles are obtained. In detail, the solution of a multi-functional polymer may be an aqueous solution, and the amount of the multi-functional polymer may be about 70 to about 120 parts by weight and the amount of the metal precursor may be about 40 to about 90 parts by weight, based on 100 parts by weight of water.

According to one or more embodiments of the present invention, the method of preparing a conductive nano ink composition is free from a heating step.

A conductive nano ink composition prepared by the method is provided.

One or more embodiments of the present invention provide a conductive nano ink composition wherein the amount of a multi-functional polymer is about 70 to about 120 parts by weight and the amount of a metal precursor is about 40 to about 90 parts by weight based on 100 parts by weight of water.

The type and molecular weight of the multi-functional polymer, and the type of the metal precursor are the same as those explained above, and thus a detailed explanation thereof will not be given.

The conductive nano ink composition may further include a dispersant, for example, BYK-108 (produced by BYK Additives & Instruments) or Anti-Terra-U (produced by BYK Additives and Instruments).

Although one or more embodiments of the present invention are exemplarily shown in detail below, the one or more embodiments of the present invention are not limited thereto.

### EXAMPLES

### Example 1

A solution of a multi-functional polymer was prepared by completely dissolving 189 parts by weight of polyvinylpyrrolidone having a molecular weight of 10,000 daltons in 200 parts by weight of distilled water to obtain a polymer solution. 126 parts by weight of silver nitrate (AgNO₃) was additionally dissolved in the polymer solution to obtain a reaction solution. The reaction solution was stirred at 1,000 rpm for 15 minutes at 25° C.

As silver ions were reduced due to the polyvinylpyrrolidone, the reaction solution turned transparent yellow. The reaction solution was left at room temperature for 3 hours after the stirring was stopped. As the reaction gradually proceeded, the reaction solution turned transparent reddish brown, and color density increased.

Silver nanoparticles obtained after the reaction was finished had a mean particle size of about 7 nm. The silver nanoparticles were left for 1 month, and then the particle size and distribution of the silver nanoparticles were measured again and compared with those of the silver nanoparticles before the silver nanoparticles were left for 1 month. There was no great difference in the particle size and the distribution of the silver nanoparticles between before and after the silver nanoparticles were left for 1 month, and the silver nanoparticles were maintained in a good dispersed state both before and after the silver nanoparticles were left for 1 month.

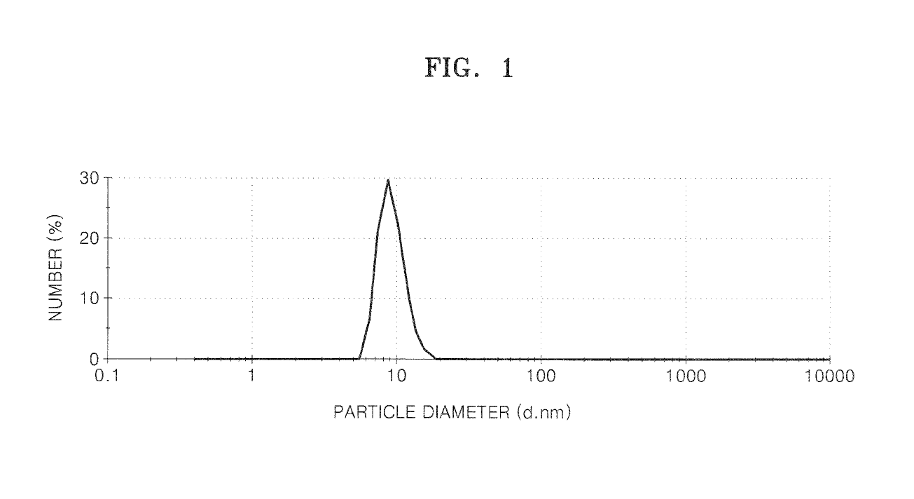

A silver nano colloid prepared by the method was analyzed using a particle size analyzer (produced by Malvern) and a result of the analysis is shown in FIG. 1.

In order to improve dispersibility and adjust viscosity, 5 parts by weight of a dispersant BYK-180 (produced by BYK Additives & Instruments) based on 100 parts by weight of water, was added to the silver nano colloid to completely prepare a silver nano conductive ink.

### Example 2

169 parts by weight of polyvinylpyrrolidone having a molecular weight of 10,000 daltons was completely dissolved in 200 parts by weight of distilled water to obtain a polymer solution. 113 parts by weight of chloroauric acid (HAuCl₄) was additionally dissolved in the polymer solution to obtain a reaction solution. The reaction solution was stirred at 1000 rpm for 15 minutes at 25° C. to obtain a gold nano colloid.

In order to improve dispersibility and adjust viscosity, 5 parts by weight of a dispersant, for example, BYK-180 (produced by BYK Additives & Instruments), based on 100 parts by weight of water, was added to the gold nano colloid to completely prepare a gold nano conductive ink.

As described above, according to the one or more of the above embodiments of the present invention, since the method may form a large number of metal nanoparticles at room temperature without a heating process for reducing metal ions and performing a reaction, operating costs may be reduced. Since an external heat source is not used, equipment investment costs may be reduced.

Furthermore, since fine secondary particles are gradually absorbed into a large number of fine primary particles that are formed by stirring so as to achieve particle size uniformity, mono-dispersed metal nanoparticles may be prepared and a manufacturing process may be simplified.

What is claimed is:

1. A method of preparing a conductive nano ink composition, the method comprising:
mixing a metal precursor in a solution of a multi-functional polymer having a chemical reduction function and a particle growth suppression function to form a mixture solution;
forming primary particles by stirring the mixture solution at about 800 rpm to about 1,200 rpm for about 10 minutes to about 20 minutes; and
forming secondary particles by leaving the mixture solution at room temperature to prepare a conductive nano ink composition.

2. The method of claim 1, wherein the multi-functional polymer has a molecular weight ranging from 10,000 to 50,000 daltons.

3. The method of claim 1, wherein the multi-functional polymer is one or more selected from the group consisting of polyvinylpyrrolidone, polyethylenimine, and polyhexanediol diacrylate.

4. The method of claim 1, wherein the metal precursor is a compound including one or more metals selected from the group consisting of silver (Ag), gold (Au), platinum (Pt), copper (Cu), nickel (Ni), and palladium (Pd).

5. The method of claim 1, wherein the metal precursor is a nitrate, an acetate or a chloride comprising one or more metals selected from the group consisting of silver (Ag), gold (Au), platinum (Pt), copper (Cu), nickel (Ni), and palladium (Pd).

6. The method of claim 1, wherein the metal precursor is AgNO₃, HAuCl₄, H₂PtCl₆, or Cu(C₂H₃O₂)₂.

7. The method of claim 1, wherein the secondary particles are formed by leaving the mixture solution at a temperature ranging from about 23° C. to about 27° C.

8. The method of claim 1, wherein the solution of the multi-functional polymer is an aqueous solution, and the amount of the multi-functional polymer is about 70 to about 120 parts by weight, based on 100 parts by weight of water, and the amount of the metal precursor is about 40 to about 90 parts by weight, based on 100 parts by weight of water.

9. The method of claim 1, wherein the method is free from a heating step.

10. The method of claim 1, wherein the mixture solution is free from an additional reducing agent.

11. A conductive nano ink composition prepared by the method of claim 1.

12. The conductive nano ink composition of claim 11, wherein the solution of the multi-functional polymer is an aqueous solution, and the amount of the multi-functional polymer is about 70 to about 120 parts by weight, based on 100 parts by weight of water, and the amount of the metal precursor is about 40 to about 90 parts by weight, based on 100 parts by weight of water.

13. A conductive nano ink composition, comprising:
mono-dispersed metal nanoparticles; and
a multifunctional polymer selected from the group consisting of polyvinylpyrrolidone, polyethylenimine, polyhexanediol diacrylate, and mixtures thereof.

14. The conductive nano ink composition of claim 13, wherein the mono-dispersed metal nanoparticles comprise one or more metals selected from the group consisting of Ag, Au, Pt, Cu, Ni, and Pd.

15. The conductive nano ink composition of claim 13, further comprising a dispersant.

16. A method of preparing a conductive nano ink composition, the method comprising:
stirring a mixture solution comprised of a metal precursor in an aqueous solution of a multifunctional polymer to reduce a metal ion of the metal precursor by the multifunctional polymer; and
placing the mixture solution at a temperature ranging from about 23° C. to about 27° C. to form mono-dispersed metal nanoparticles.

17. The method of claim 16, wherein the multi-functional polymer is one or more selected from the group consisting of polyvinylpyrrolidone, polyethylenimine, and polyhexanediol diacrylate, and the metal precursor is a nitrate, an acetate, or a chloride comprising one or more metals selected from the group consisting of silver (Ag), gold (Au), platinum (Pt), copper (Cu), nickel (Ni), and palladium (Pd).

18. The method of claim 16, wherein the stirring of the mixture solution comprises stirring the mixture solution at about 800 rpm to about 1,200 rpm for about 10 minutes to about 20 minutes.

19. The method of claim 16, wherein the amount of the multi-functional polymer is about 70 to about 120 parts by weight, based on 100 parts by weight of water, and the amount of the metal precursor is about 40 to about 90 parts by weight, based on 100 parts by weight of water.

20. The method of claim 17, further comprising adding a dispersant to the mono-dispersed metal nanoparticles.
